(19) United States
(12) Patent Application Publication
(10) Pub. No.: US 2024/0429457 A1
(43) Pub. Date: Dec. 26, 2024

(54) SOLID-STATE ELECTROCHEMICAL CELL

(71) Applicant: Dyson Technology Limited, Wiltshire (GB)

(72) Inventors: Neil Ross SIM, Swindon (GB); Michael Edward RENDALL, Newbury (GB); Samuel John ALEXANDER, Gloucester (GB)

(21) Appl. No.: 18/694,177

(22) PCT Filed: Sep. 26, 2022
(86) PCT No.: PCT/GB2022/052429

§ 371 Date: Mar. 21, 2024

(30) Foreign Application Priority Data
Sep. 30, 2021 (GB) 2114036.3

(51) Int. Cl. H01M 10/0585; H01M 4/02; H01M 4/139; H01M 4/70

(52) U.S. Cl. CPC H01M 10/0585; H01M 4/139; H01M 4/70; H01M 2004/028

(57) ABSTRACT

Solid-state electrochemical cells are disclosed. In examples, the cell comprises a sintered cathode layer, an electrolyte layer, an anode layer arranged on at least part of the electrolyte layer, an anode current collector, and a cathode current collector. The sintered cathode layer comprises side surfaces having portions which extend in planes oblique to the plane in which the top and/or bottom surfaces of the sintered cathode layer extend. The electrolyte layer is arranged on at least one of these portions; the cathode current collector is arranged on at least another of these portions.

### TECHNICAL FIELD

The present invention relates to solid-state electrochemical cells, methods of providing solid-state electrochemical cells, methods of providing sintered cathode sheets, laminate materials, methods of providing laminate materials, battery stacks comprising a plurality of solid-state electrochemical cells, and electrically-powered devices comprising solid-state electrochemical cells.

### BACKGROUND

Solid-state electrochemical cells typically comprise a cathode, and anode, optionally a separator for separating the cathode and anode, and current collectors disposed on the anode and cathode.

The cathode of a solid-state electrochemical cell is typically manufactured through supplying multiple layers of cathode material to a substrate (e.g. a cathode current collector) until a cathode of a suitable thickness is provided. Such a method is time-consuming, and leads to imperfections in the cathode layer of the cell (e.g. unintended variations in layer thickness) due to the multiple steps of depositing cathode material.

It is desirable for solid-state electrochemical cells to be arranged in a battery stack such that the anode current collector and cathode current collector are arranged apart, to reduce the likelihood of shorting. Previously this has been achieved by e.g. manufacturing an electrochemical cell, and then carrying out chemical etching or laser ablation on portions of an electrochemical cell to expose particular components of the cell in particular areas, and/or printing material onto particular areas of the electrochemical cell. However, such methods are expensive and time-consuming.

### SUMMARY

In examples of a first aspect of the present disclosure there is provided a solid-state electrochemical cell comprising a sintered cathode layer, an electrolyte layer, an anode layer, an anode current collector, and a cathode current collector.

The sintered cathode layer comprises a bottom surface extending along a first plane, and a top surface opposing the bottom surface, the top surface extending along a second plane relative to the first plane.

The sintered cathode layer comprises a first side surface comprising a first portion connected to the bottom surface of the sintered cathode layer by a first bottom side edge, and a second portion connected to the top surface of the sintered cathode layer by a first top side edge. The first portion extends along a plane oblique to the first plane.

The sintered cathode layer comprises a second side surface opposing the first side surface, the second side surface comprising a first portion connected to the bottom surface of the sintered cathode layer by a second bottom side edge, and a second portion connected to the top surface of the sintered cathode layer by a second top-side edge. The second portion extends along a plane oblique to the second plane.

The electrolyte layer is arranged on at least part of the bottom surface, the first portion of the first side surface, and the first portion of the second side surface of the sintered cathode layer. The anode layer is arranged on at least part of the electrolyte layer, and the anode current collector arranged on at least part of the anode layer. The cathode current collector is arranged on at least part of the top surface, the second portion of the first side surface, and the second portion of the second side surface of the sintered cathode layer.

The inventors have identified that a solid-state electrochemical cell as described hereinabove provides an exposed current collector on at least one side of the cell, meaning that it is more easily electrically connected to other cells in a battery with a reduced likelihood of shorting (because it is spaced apart from the opposing current collector).

Further, examples of cells as described hereinabove are manufactured by providing cathode material in a single step, and sintering that cathode material to provide a sintered cathode sheet, thereby reducing the time needed to manufacture a cathode layer and reducing the likelihood of imperfections of the cathode layer introduced through multiple depositions of material. Moreover, the sintered cathode sheet is sufficiently robust that, in manufacturing the cell, the sintered cathode sheet acts as a substrate to which the material forming the other layers of the cell are provided.

Further still, cells as described hereinabove are typically manufactured by cutting a laminate structure into portions which correspond to solid-state electrochemical cells having sides coated with current collector. That is, it is unnecessary to carry out expensive and time-consuming processes such as laser ablation, printing, or etching to provide a solid-state electrochemical cell having sides coated with current collector.

Each of the sintered cathode, electrolyte, anode, anode current collector, and cathode current collector are provided in the solid-state electrochemical cell as layers. A layer may also be referred to as a sheet; a sheet may be referred to as a layer in examples where the sheet forms part of laminate structure (e.g. a structure comprising a plurality of layers). A layer extends in a first dimension (length), a second dimension perpendicular to the first dimension (width), and a third dimension perpendicular to both the first and second dimensions (thickness). The thickness of the layer is typically the smallest dimension between planar surfaces layer of an electrochemical cell described herein. Each layer of the electrochemical cell has a thickness.

A layer typically comprises at least a bottom surface, a top surface, a first side surface, and a second side surface. The bottom surface is typically opposed to the top surface, and the first side surface is typically opposed to the second side surface. In examples, at least a portion of each of these surfaces is substantially planar, e.g. a portion of each of these surfaces is flat (within tolerances acceptable in the art).

The thickness of a layer is typically the smallest dimension between the bottom surface and top surface of the layer where the bottom surface is opposed to the top surface.

In examples, the bottom surface of each layer is connected to the first side surface by a first bottom-side edge, and is connected to the second side surface by a second bottom-side edge. In examples, the top surface of each layer is connected to the first side surface by a first top-side edge, and is connected to the second side surface by a second top-side edge. The edges are independently rounded edges (e.g. one or more of the edges has a radius) or straight edges (e.g. one or more of the edges does not have an appreciable radius, within tolerances acceptable in the art).

At least a portion of a layer is typically substantially planar e.g. a portion of the layer comprises a surface and another opposing surface, both of which are flat (within tolerances acceptable in the art), the thickness between the surface and opposing surface being uniform along the portion (within acceptable tolerances in the art). In examples, a central portion of a layer (a portion comprising part of the top surface and bottom surface of the layer, but apart from the first side surface and the second side surface) is substantially planar.

In examples, the bottom surface of each layer is opposed to some or all of the top surface of the layer. In examples, the layer is chamfered-at the first and/or second side of the layer, the bottom surface extends further along the first plane in the direction of that side than the top surface extends along the second plane in the direction of that side, and vice versa, such that at least one of the first side surface or second side surface of the layer extends in a plane oblique to the first plane and/or second plane. “Oblique” as used herein refers to an angle between two shapes which are neither substantially parallel (e.g. parallel within acceptable tolerances in the art) nor substantially perpendicular (e.g. perpendicular within acceptable tolerances in the art). Accordingly, with reference to planes, where the intersection of two planes forms an oblique angle, those planes are oblique to each other. Planes oblique to one another are neither substantially parallel nor substantially perpendicular in at least two dimensions. In some examples, oblique planes extend along one dimension in common—these oblique planes are referred to as inclined planes. Oblique planes as referred to herein are explained further with reference to FIG. 2B hereinbelow. In any of the examples described herein, each of the oblique plane(s) referred to is suitably an inclined plane e.g. as depicted in FIG. 2B.

In examples, a layer has a substantially uniform thickness along portions wherein the bottom surface is opposed to the top surface. In these examples, the whole layer is substantially planar, or the whole layer is not substantially planar but nevertheless has a substantially uniform thickness along portions wherein the bottom surface is opposed to the top surface (e.g. the layer of uniform thickness bends to conform with a surface on which it is disposed). For example, the layer has a substantially planar central portion and curved portion(s) between the central portion and the first side surface and/or the second side surface.

In examples, the second plane along which the top surface of the sintered cathode layer extends is substantially parallel (e.g. parallel within acceptable tolerances in the art) to the first plane along which the bottom surface of the sintered cathode layer extends.

In examples, a first layer (or a portion of a first layer) is arranged on a second layer (or portion of a second layer). In examples, the first layer (or portion of the first layer) abuts the second layer (or portion of the second layer); in other examples, the first layer (or portion of the first layer) arranged on the second layer (or portion of the second layer) does not abut the second layer (or portion of the second layer), e.g. there is a further layer interposed between the first layer and second layer which abuts both the first and second layer. That is, in examples a layer is arranged on another layer even though the layers do not abut.

The portion of electrolyte layer which is arranged on a portion of the first side of the sintered cathode layer is the first side portion of the electrolyte layer, and the portion of electrolyte layer which is arranged on a portion of the second side surface of the sintered cathode layer is the second side portion of the electrolyte layer. The portion of electrolyte layer which is arranged on the bottom surface of the sintered cathode layer is the central portion of the electrolyte layer.

The electrolyte layer typically comprises a bottom surface, a top surface, a first side surface, and a second side surface. In examples, the first side portion of the electrolyte layer comprises a portion of the bottom surface, a portion of the top surface, and the first side surface of the electrolyte layer. In examples, the second side portion of the electrolyte layer comprises a portion of the bottom surface, a portion of the top surface, and the second side surface of the electrolyte layer.

Typically, the top surface of the electrolyte layer abuts the sintered cathode layer along the bottom surface, the first portion of the first side surface, and the first portion of the second side surface of the sintered cathode layer.

The anode layer is typically arranged on at least the first side portion and second side portion of the electrolyte layer and, in examples, the central portion of the electrolyte layer. In examples, the anode layer abuts the first side portion, central portion, and second side portion of the electrolyte layer. These portions of anode layer are in turn referred to as the first side portion, central portion, and second side portion of the anode layer, respectively.

The anode layer typically comprises a bottom surface, a top surface, a first side surface, and a second side surface. In examples, the first side portion of the anode layer comprises a portion of the bottom surface, a portion of the top surface, and the first side surface of the anode layer. In examples, the second side portion of the anode layer comprises a portion of the bottom surface, a portion of the top surface, and the second side surface of the anode layer.

In examples, the top surface of the anode layer abuts the bottom surface of the electrolyte layer. In particular examples, the top surface of the anode layer abuts the electrolyte layer along the bottom surface of the first side portion, central portion, and second side portion of the electrolyte layer.

The anode current collector is typically arranged on at least the first side portion and second side portion of the anode layer and, in examples, the central portion of the anode layer. In examples, the anode current collector abuts the first side portion, central portion, and second side portion of the anode layer. These portions of anode current collector are in turn referred to as the first side portion, central portion, and second side portion of the anode current collector, respectively.

The anode current collector typically comprises a bottom surface, a top surface, a first side surface, and a second side surface. In examples, the first side portion of the anode current collector comprises a portion of the bottom surface, a portion of the top surface, and the first side surface of the anode current collector. In examples, the second side portion of the anode layer comprises a portion of the bottom surface, a portion of the top surface, and the second side surface of the anode current collector.

In examples, the top surface of the anode current collector abuts the bottom surface of the anode layer. In particular examples, the top surface of the anode current collector abuts the anode layer along the bottom surface of the first side portion, central portion, and second side portion of the anode layer.

The portion of cathode current collector which is arranged on the first side surface of the sintered cathode layer is the first side portion of the cathode current collector, and the portion of cathode current collector which is arranged on a portion of the second side surface of the sintered cathode layer is the second side portion of the cathode current collector. The portion of cathode current collector which is arranged on the top surface of the sintered cathode layer is the central portion of the cathode current collector.

The cathode current collector typically comprises a bottom surface, a top surface, a first side surface, and a second side surface. In examples, the first side portion of the cathode current collector comprises a portion of the bottom surface, a portion of the top surface, and the first side surface of the current collector. In examples, the second side portion of the cathode current collector comprises a portion of the bottom surface, a portion of the top surface, and the second side surface of the cathode current collector.

Typically, the bottom surface of the cathode current collector abuts the sintered cathode layer along the top surface, the second portion of the first side surface, and the second portion of the second side surface of the sintered cathode layer.

The second portion of the second side surface of the sintered cathode layer extends along a plane oblique to the second plane. In examples, the second side portion of the cathode current collector coats this oblique portion. The inventors have identified that, due to the oblique angle, the cathode current collectors at the second side of the cell is more easily coated in electrically-insulating material when cells are arranged in a battery stack, while leaving the anode current collectors at the second side exposed (and thus available for electrical connection with anode current collectors of other cells in the battery stack at the second side).

Similarly, the first portion of the first side surface of the sintered cathode layer extends along a plane oblique to the second plane. In examples, the first side portion of the anode current collector is arranged on this oblique portion (e.g. the first side portion of the electrolyte layer abuts the first portion of the first side surface of the sintered cathode layer; the first side portion of the anode layer abuts the first side portion of the electrolyte layer; and the first side portion of the anode current collector abuts the first side portion of the anode layer). The inventors have identified that, due to the oblique angle, the anode current collectors at the first side of the cell is more easily coated in electrically-insulating material when cells are arranged in a battery stack, while leaving the cathode current collectors at the first side exposed (and thus available for electrical connection with anode current collectors of other cells in the battery stack at the first side).

In examples, the second portion of the first side surface extends along a plane which is at least one of: oblique to the plane along which the first portion of the first side surface extends; perpendicular to the plane along which the first portion of the first side surface extends; oblique to the second plane; or perpendicular to the second plane.

In particular examples, the second portion of the first side surface of the sintered cathode layer extends along a plane which is substantially perpendicular to the second plane. In examples, the first side portion of the cathode current collector coats this perpendicular portion. The inventors have identified that, due to the substantially perpendicular angle, a flat, exposed cathode current collector is exposed at the first side of the cell. Accordingly, the cathode current collectors of a plurality of solid-state electrochemical cells are more easily connected with other cathode current collectors by an electrically-conductive material in a battery stack.

In examples, the first portion of the second side surface of the sintered cathode layer extends along a plane which is at least one of: oblique to the plane along which the second portion of the second side surface extends; perpendicular to the plane along which the second portion of the second side surface extends; oblique to the first plane; or perpendicular to the first plane.

In particular examples, the first portion of the second side surface of the sintered cathode layer extends along a plane which is substantially perpendicular to the first plane. In examples, the second side portion of the anode current collector is arranged on this perpendicular portion (e.g. the second side portion of the electrolyte layer abuts the first portion of the second side surface of the sintered cathode layer; the second side portion of the anode layer abuts the second side portion of the electrolyte layer; and the second side portion of the anode current collector abuts the second side portion of the anode layer). The inventors have identified that, due to the substantially perpendicular angle, a flat, exposed anode current collector is exposed at the second side of the cell. Accordingly, the anode current collectors of a plurality of solid-state electrochemical cells are more easily connected with other anode current collectors by an electrically-conductive material in a battery stack.

Typically, the structure of the solid-state electrochemical cell as disclosed hereinabove means that, at one end of the electrochemical cell a flat surface with only the cathode current collector is exposed, and at the other end of the cell a flat surface with only the anode current collector is exposed. Advantageously, examples of cells having this structure are stackable to form a battery stack where the cathode current collectors of the cell are more easily electrically connected at one end of the battery stack with a reduced chance of shorting between the layers of the cell, and the anode current collectors of the cell are more easily connected at the other end of the battery stack with a reduced chance of shorting between the layers of the cell.

A sintered cathode layer is typically a layer of cathode material which has been sintered to provide a cathode layer. The layer of cathode material is sintered to provide the cathode layer before it is combined with the other layers of the solid-state electrochemical cell, or the layer of cathode material is combined with the other layers of the solid-state electrochemical and sintered to provide a solid-state electrochemical cell comprising a sintered cathode layer.

In examples, the sintered cathode layer comprises, consists essentially of, or consists of: lithium cobalt oxide (LiCoO₂), typically referred to as LCO; lithium manganese oxide (LiMn₂O₄), typically referred to as LMO; lithium titanate (Li₄Ti₅O₁₂—typically referred to as LTO); lithium nickel manganese cobalt oxide (LiNi_{1-x-y}MnₓCo_{y}O₂), typically referred to as NMC; lithium iron phosphate (LiFePO₄), typically referred to as LFP, lithium nickel cobalt aluminium oxide (LiNi_{1-x-y}CoₓAl_{y}O₂), typically referred to as NCA; lithium sulfide (Li₂S); silver vanadium oxide (AgV₂O_{5.5}), typically referred to as SVO; and combinations thereof. In particular examples, the sintered cathode layer comprises LTO.

In examples, the anode layer comprises, consists essentially of, or consists of: silicon, carbon, indium tin oxide (ITO), molybdenum dioxide (MoO₂), lithium titanate (Li₄Ti₅O₁₂—typically referred to as LTO), lithium alloy, metallic lithium, or combinations thereof. Where the anode comprises carbon, the anode comprises any suitable carbon-based material. For example, the anode comprises graphite, graphene, hard carbon, activated carbon, and/or carbon black.

The electrolyte layer typically comprises ceramic material. In examples, the electrolyte layer is a crystalline lithium-ion (‘Li-ion’) ceramic. The electrolyte layer typically functions as a separator between the cathode and the anode, preventing the anode and cathode from coming into direct contact and thereby short-circuiting the cell.

In examples, the electrolyte layer comprises, consists essentially of, or consists of: perovskite-type Li-ion conductor; anti-perovskite-type Li-ion conductor; garnet-type Li-ion conductor; sodium super ionic Li-ion conductor (NASICON); NASICON-related Li-ion conductor; lithium super ionic conductor (LISICON); LISICON-related Li-ion conductor; thio-LISICON; thio-LISICON-related Li-ion conductor; lithium phosphorous oxy-nitride (LiPON); related amorphous glassy type Li-ion conductors, or combinations thereof. In particular examples, the electrolyte layer comprises lithium phosphorous oxy-nitride (LiPON), the LiPON having the following formula: LiₓPO_{y}N_{z} where x=2y+3z−5, and x<4. In examples, the electrolyte layer comprises at least 50 wt %, 80 wt %, 90 wt %, 95 wt % or 99 wt % LiPON by dry weight of the ceramic layer. In some examples, the electrolyte consists essentially of, or consists of, LiPON.

Each current collector (the anode current collector and cathode current collector) is typically a metal foil (e.g. copper, nickel, stainless steel), metal screen, metal film on a polymer film or sufficiently conductive SiO₂ layer, or any other known substrate or barrier layer.

In examples of a second aspect of the present disclosure, there is provided a method of providing a sintered cathode sheet. The method comprises providing a cathode sheet comprising a bottom surface extending along a first plane and a top surface extending along a second plane relative to the first plane, scoring the bottom surface of the cathode sheet to provide a groove in the bottom surface of the cathode sheet, wherein at least a portion of a first side of the groove extends along a plane oblique to the first plane, and sintering the cathode sheet to provide the sintered cathode sheet.

Advantageously, a sintered cathode sheet is sufficiently robust that, in manufacturing a solid-state electrochemical cell, the sintered cathode sheet acts as a substrate to which the other layers of the cell are provided.

A “groove” as used herein refers to a depression in the surface of a layer which forms a channel that extends along an axis. In examples, a groove in the surface of a layer corresponds with a localised reduction in thickness of the layer, e.g. a groove in a bottom surface opposed to a planar portion of a top surface, such that the portion of the layer at the groove has a reduced thickness compared with the portions of the layer surrounding the groove. In other examples, a groove in the surface of a layer does not correspond with a localised reduction in thickness of the layer, such that the layer has substantially uniform thickness across the groove and at the portions surrounding the groove, e.g. a groove in a bottom surface opposed to a corresponding protrusion in the top surface.

“Scoring” as used herein refers to removing material from a surface of a sheet to provide a groove in the surface of the sheet, or compressing a portion of the sheet to provide a groove in the sheet. Scoring is performed according to any suitable method in the art, such as by using a roller or cutting knife. Scoring is performed on the sheet prior to sintering the sheet, and/or after the sintering of the sheet. In examples where the scoring is performed after the sintering of the sheet, the scoring is performed by e.g. laser ablation.

In examples, at least a portion of a second side of the groove of the bottom surface, opposed to the first side of the groove of the bottom surface, extends along a plane perpendicular to the first plane.

In examples, the method further comprises scoring the top surface of the cathode sheet to provide a groove in the top surface of the cathode sheet, wherein at least a portion of a first side of the groove extends along a plane oblique to the second plane.

In examples, at least a portion of a second side of the groove of the top surface, opposed to the first side of the groove of the top surface, extends in a plane perpendicular to the second plane.

In examples, the second plane is substantially parallel to the first plane.

The planes in which the portions of the sides of the grooves extend typically correspond to the first side and second side of the sintered cathode layer in the solid-state electrochemical cells described hereinabove in relation to the first aspect.

In examples, the providing the cathode sheet comprises providing particulate cathode material, and forming the particular cathode material into a sheet of cathode material.

The forming the sheet of cathode material is performed according to any suitable process in the art. For example, the forming the sheet of cathode material comprises rolling and/or compressing particular cathode material into a sheet of cathode material.

As explained hereinabove in relation to the first aspect, the providing cathode sheet through e.g. one step of supplying particular cathode material and forming a sheet, and sintering the sheet, reduces the time needed to manufacture a cathode layer and reduces the likelihood of imperfections of the cathode layer introduced through multiple depositions of material.

The particulate cathode material comprises any of the cathode materials described in relation to examples of the first aspect and precursors thereof.

In examples of a third aspect of the present disclosure, there is provided laminate material comprising a sintered cathode layer, an electrolyte layer, an anode layer, an anode current collector, and a cathode current collector.

The sintered cathode layer comprises a bottom surface extending along a first plane and a top surface extending along a second plane relative to the first plane. The sintered cathode sheet comprises at least one groove along the bottom surface of the sintered cathode layer wherein at least a portion of a first side of the groove extends along a plane oblique to the first plane.

The electrolyte layer is arranged on at least part of the bottom surface of the sintered cathode layer and the groove of the bottom surface of the sintered cathode layer. The electrolyte layer comprises a groove corresponding to the groove of the sintered cathode layer.

The anode layer is arranged on at least part of the electrolyte layer including at least part of the groove of the electrolyte layer. The anode layer comprises a groove corresponding to the groove of the electrolyte layer.

The anode current collector is arranged on at least part of the anode layer including at least part of the groove of the anode layer. The anode current collector comprises a groove corresponding to the groove of the anode layer.

The cathode current is arranged on at least part of the sintered cathode layer.

The inventors have identified that a laminate material as described above is processable to provide, in examples, a plurality of solid-state electrochemical cells by separating portions of the laminate material (e.g. cutting the laminate material along the grooves). That is, a solid-state electrochemical cell as described hereinabove in relation to the first aspect is provided in a single step by separating portions of the laminate material, obviating the need for expensive and time-consuming steps (e.g. laser ablation, printing, or etching) to provide a cell having opposing current collectors on its opposing sides.

In examples, the sintered cathode sheet comprises at least one groove along the top surface of the sintered cathode layer, at least a portion of a first side of the groove extending along a plane oblique to the second plane. The cathode current collector is arranged on at least part of the groove of the top surface of the sintered cathode layer, the cathode current collector comprising a groove corresponding to the groove of the sintered cathode layer.

In examples, the groove of the top surface corresponds to the groove of the bottom surface. The groove of the top surface is off-set from its corresponding groove in the bottom surface; the axes along which both grooves in the top and bottom surface extend together lie along a plane oblique to the first plane along which the bottom surface extends and the second plane along which the second surface extends. In examples, this oblique plane corresponds to the plane along which portions of the laminate material are separated to provide a solid-state electrochemical cell.

In examples, the at least one groove in the top surface of the sintered cathode sheet is a plurality of grooves comprising a first groove and a second groove, the first groove and second groove extending along substantially parallel axes. A plurality of grooves means that a greater number of solid-state electrochemical cells are obtainable from the laminate material.

In examples, the sintered cathode sheet further comprises at least one perpendicular groove in the top surface of the sintered cathode sheet, the perpendicular groove extending along an axis perpendicular to the at least one groove in the top surface of the sintered cathode sheet.

In examples, the at least one groove in the bottom surface of the sintered cathode sheet is a plurality of grooves comprising a first groove and a second groove, the first groove and second groove extending along substantially parallel axes.

These perpendicular grooves allow for further separation of the laminate material to provide an even greater number of solid-state electrochemical cells.

In examples of a fourth aspect of the present disclosure there is provided a method of providing a laminate material, such as a laminate material according to examples of the third aspect. The method comprises providing a sintered cathode sheet by a method according to examples of the second aspect described hereinabove, supplying an electrolyte material to at least a portion of the bottom surface of the sintered cathode sheet including the groove, thereby providing an electrolyte layer having a groove corresponding to the groove in the bottom surface of the sintered cathode sheet, and supplying an anode material to at least a portion of the electrolyte layer, thereby providing an anode layer comprising a groove corresponding to the groove of the electrolyte layer.

In examples, the method further comprises supplying a current collector material to at least a portion of the anode layer, thereby providing an anode current collecting comprising a groove corresponding to the groove of the anode layer.

In examples, the providing the sintered cathode sheet comprises scoring the top surface of the cathode sheet to provide a groove in the top surface of the cathode sheet, at least a portion of a first side of the groove extending along a plane oblique to the second plane. The method of providing the laminate material further comprises supplying a current collector material to at least a portion of the top surface of the sintered cathode sheet including the groove, thereby providing a current collector layer comprising a groove corresponding to the groove in the top surface of the sintered cathode sheet.

The inventors have identified that, by using a sintered cathode sheet as a substrate in a manufacturing method as described above, a laminate material corresponding to a plurality of solid-state electrochemical cells is provided in bulk.

The sintered cathode sheet acts as a substate on which the further layers of the laminate material are provided. The material of the further layers is, for example, provided sequentially. In examples, the material supplied to the substrate is processed (e.g. sintered, cross-linked) before the material of a subsequent layer is provided. In other examples, no processing of the material is carried out before the material of the next layer is provided.

The electrolyte material and anode material are supplied according to any suitable technique in the art. For example, the electrolyte material is deposited on the bottom surface of the sintered cathode sheet; the anode material is deposited on the bottom surface of the electrolyte layer.

In examples, the depositing comprises physical vapour depositing. Physical vapour deposition (PVD) is an example of vacuum deposition and refers to a process wherein a condensed material is vaporised, and then at least some of the vaporised material condenses on a substrate to provide a condensed layer. Examples of PVD include thermal deposition (also referred to as evaporative deposition), and sputtering.

In examples, the depositing comprises chemical vapour depositing. Chemical vapour deposition (CVD) is an example of vacuum deposition and refers to a process wherein a substrate is exposed to one or more volatile precursors, which react and/or decompose on the substrate surface to produce a layer. Examples of CVD include low pressure chemical vapour deposition (LPCVD) and plasma enhanced chemical vapour deposition (PECVD).

In examples, the depositing comprises electrophoretic depositing. Electrophoretic deposition refers to a process wherein colloidal particles suspended in a liquid medium migrate under the influence of an electric field (electrophoresis) and are deposited onto a substrate. Examples of electrophoretic deposition include electrocoating, electrodeposition, and electrophoretic coating, and electrophoretic painting.

In examples, the depositing comprises casting. Examples of casting include spray casting, sheet casting, and spin casting.

In examples, the electrolyte material, anode material, anode current collector and/or cathode current collector are deposited such that the layer formed by that material has a substantially uniform thickness.

In examples, although surfaces of each of the layers comprise grooves, all layers apart from the sintered cathode layer have a substantially uniform thickness-these layers conform to the shape of the grooves in the sintered cathode layer substrate on which they were formed, thereby providing grooves in the surfaces of these further layers.

In examples of a fifth aspect of the present disclosure there is provided a method of providing a solid-state electrochemical cell comprising providing a laminate material according to examples of the third aspect described hereinabove, and separating a first portion of the laminate material from a second portion of the laminate material, thereby providing at least one solid-state electrochemical cell.

In examples, the separating comprises cutting (e.g. laser cutting) the laminate material along a plane connecting the groove of the bottom surface of the sintered cathode sheet and the groove of the top surface of the sintered cathode sheet.

In examples, the plane of cutting corresponds to the plane along which the portion of the first side of the groove of the bottom surface of the sintered cathode sheet extends and/or the plane along which the portion of the first side of the groove of the top surface of the sintered cathode sheet extends. In examples, the plane of cutting corresponds to the plane along which the axes of the grooves in both the bottom surface and top surface extend.

In examples of a sixth aspect of the present disclosure there is provided a battery stack comprising a plurality of laminate electrochemical cells according to the first aspect described hereinabove.

In examples, the plurality of electrochemical cells comprises a first electrochemical cell and a second electrochemical cell, configured such that the anode current collector of the first cell abuts the anode current collector of the second cell. In particular examples, the central portions of the anode current collectors abut.

In examples, the plurality of electrochemical cells further comprises a third electrochemical cell, configures such that the cathode current collector of the third cell abuts the cathode current collector of the first cell or second cell. In particular examples, the central portions of the cathode current collectors abut.

In examples, for each of the electrochemical cells, the portion of cathode current collector arranged on the second portion of the second side surface of the sintered cathode layer is coated with an electrically-insulating material. For example, the second side portion of cathode current collector which lies along a plane oblique to the second surface of the sintered cathode layer is coated with an electrically-insulating material.

In examples, for each of the electrochemical cells, a portion of the anode current collector corresponding to the first portion of the first side surface of the sintered cathode layer is coated with an electrically-insulating material. For example, the first side portion of anode current collector which lies along a plane oblique to the first surface of the sintered cathode layer is coated with an electrically-insulating material.

In examples, the battery stack comprises an electrically-conductive material abutting the portion of cathode current collector arranged on the second portion of the first side surface of the sintered cathode layer of each electrochemical cell, such that the cathode current collectors of the electrochemical cells are electrically connected. In examples, the portion of cathode current collector is the first side portion of the cathode current collector, which extends in a plane substantially perpendicular to the second plane of the sintered cathode layer.

In examples, the battery stack comprises an electrically-conductive material abutting a portion of the anode current collector corresponding to the first portion of the second side surface of the sintered cathode layer of each electrochemical cell, such that the anode current collectors of the electrochemical cells are electrically connected. In examples, the portion of anode current collector is the second side portion of the anode current collect, which extends in a plane substantially perpendicular to the first plane of the sintered cathode layer.

Methods of manufacturing said battery stacks also form part of the present disclosure. Said methods typically correspond to those described herein in relation to manufacture of a cell, wherein the process is repeated to build a plurality of laminate cells arranged in a laminate stack structure. In examples, the cells are arranged as described hereinabove, electrically-insulating material supplied to portions of the cells on a first side of the stack, and to portions of the cells on a second side of the stack. The first side and second side of the stack are then coated with an electrically-conductive material, thereby electrically connecting the cathode current collectors on one side of the stack, and electrically connecting the anode current collectors on the other side of the stack.

In examples of a yet further aspect of the present disclosure there is provided an electrically-powered device comprising the solid-state electrochemical cell described herein, or the battery stack described herein. An electrically-powered device is any apparatus which draws electric power from a circuit which includes the cell or battery stack, converting the electric power from the cell or battery stack to other forms of energy such as mechanical work, heat, light, and so on. In examples, the electrically-powered device is a smartphone, a cell phone, a personal digital assistant, a radio player, a music player, a video camera, a tablet computer, a laptop computer, military communications, military lighting, military imaging, a satellite, an aeroplane, a micro air vehicle, a hybrid electric vehicle, a plug-in hybrid electric vehicle, a fully electric vehicle, an electric scooter, an underwater vehicle, a boat, a ship, an electric garden tractor, an unmanned aero drone, an unmanned aeroplane, an RC car, a robotic toy, a vacuum cleaner such as a robotic vacuum cleaner, a robotic garden tool, a robotic construction utility, a robotic alert system, a robotic aging care unit, a robotic kid care unit, an electric drill, an electric mower, an electric vacuum cleaner, an electric metal working grinder, an electric heat gun, an electric press expansion tool, an electric saw or cutter, an electric sander and polisher, an electric shear and nibbler, an electric router, an electric tooth brush, an electric hair dryer, an electric hand dryer, a global positioning system (GPS) device, a laser rangefinder, a torch (flashlight), an electric street lighting, a standby power supply, uninterrupted power supplies, or another portable or stationary electronic device.

Features described herein in relation to one aspect of the present disclosure are explicitly disclosed in combination with the other aspects, to the extent that they are compatible.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a flow chart of a method of providing a sintered cathode sheet according to examples.

FIG. 2A is a schematic diagram of a cross-section of a portion of a sintered cathode sheet according to examples; FIG. 2B is a schematic diagram of oblique planes as referred to herein.

FIG. 3A is a flow chart of a method of providing a laminate material according to examples; FIG. 3B is a flow chart of a method of providing a solid-state electrochemical cell according to examples.

FIG. 4A is a schematic diagram of a cross-section of a portion of a laminate material according to examples; FIGS. 4B and 4C are enlarged views of portions of the laminate material depicted in FIG. 4A.

FIG. 5 is a schematic diagram of a perspective view of a laminate material according to examples.

FIG. 6A is a schematic diagram of a cross-section of a solid-state electrochemical cell according to examples; FIGS. 6B, 6C, and 6D are enlarged views of portions of the solid-state electrochemical cell depicted in FIG. 6A.

FIG. 7 is a schematic diagram of a cross-section of a battery stack according to examples.

FIG. 8 is a schematic diagram of an electrically-powered device according to examples.

### DETAILED DESCRIPTION

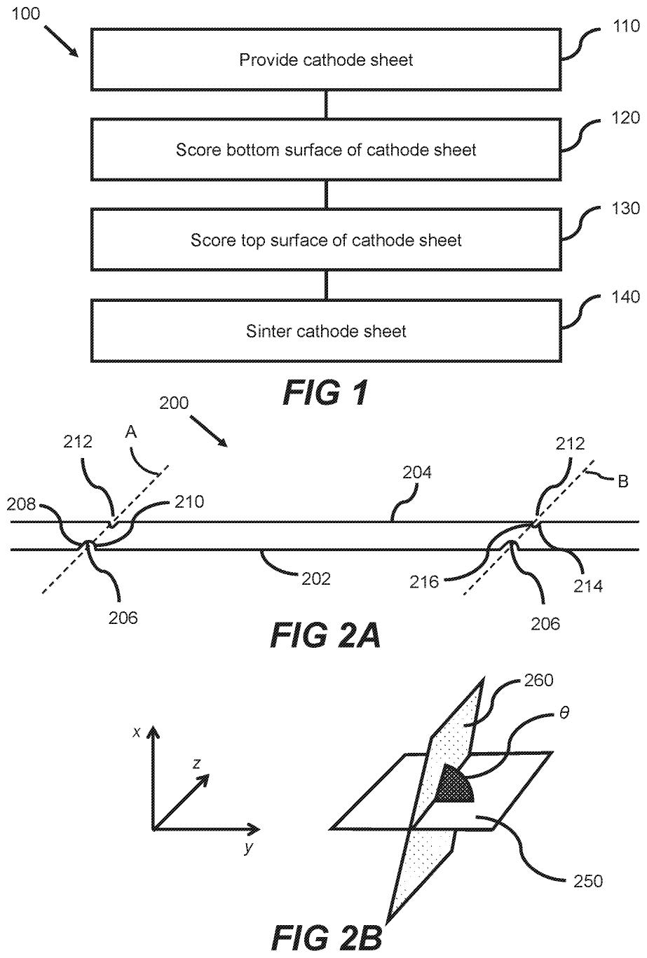

FIG. 1 is a flow chart depicting a method 100 of providing a sintered cathode sheet according to examples.

The method 100 comprises providing 110 a cathode sheet. In this example, the cathode sheet is provided by providing a particular cathode material, and forming the particulate cathode material into a sheet of cathode material (sometimes referred to as a “green sheet”). The sheet of cathode material is formed by pressing the particulate cathode material together through a roller; at this stage of the method, the material is unsintered.

The method 100 further comprises scoring 120 a bottom surface of the cathode sheet. That is, a groove (or “channel”) is provided in the bottom surface of the sintered cathode sheet. In this example, the bottom surface is scored with a knife to provide the groove in the bottom surface of the cathode sheet.

The method 100 further comprises scoring 130 a top surface of the cathode sheet. That is, a groove (or “channel”) is provided in the top surface of the cathode sheet. In this example, the top surface is scored using a knife to provide the groove in the top surface of the sintered cathode sheet.

The method 100 further comprises sintering 140 the cathode sheet to provide the sintered cathode sheet.

FIG. 2A is a schematic diagram of a cross-section of a portion of sintered cathode sheet 200 according to examples, e.g. a sintered cathode sheet 200 provided by the method 100 depicted in FIG. 1. FIG. 2B depicts oblique planes 250, 260 as referred to herein.

The sintered cathode sheet 200 has a bottom surface 202 and a top surface 204. The bottom surface 202 extends along a first plane; the top surface 204 extends along a second plane. In this example, the second plane along which the top surface 204 extends is parallel to the first plane along which the bottom surface 202 extends.

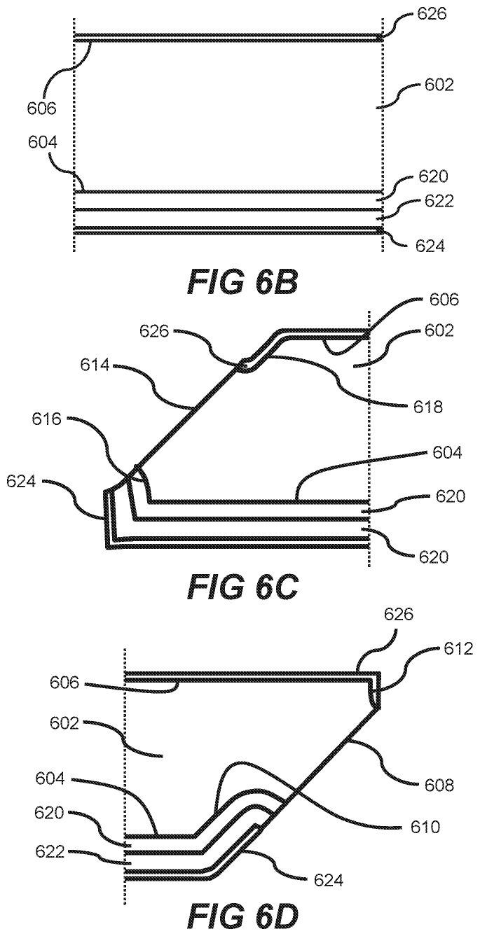

The sintered cathode sheet 200 comprises at least one groove 206 in the bottom surface of the sintered cathode sheet. In the portion of sintered cathode sheet 200 depicted in FIG. 2, there are two grooves 206 in the bottom surface 202 of the sintered cathode sheet 200. The grooves 206 extend along axes parallel to each other, in a direction perpendicular to the cross-section of FIG. 2 and parallel to the first plane. A portion of a surface of the sintered cathode sheet 200 which does not include a groove (e.g. the portion between the two grooves 206 of the bottom surface 202 depicted in FIG. 2) is referred to as “a planar portion”. The planar portions of the bottom surface 202 extend along the first plane between the grooves 206. The planar portion of the bottom surface 202 corresponds to the bottom surface 604 of the electrochemical cell 600 described with reference to FIGS. 6A to 6D.

Each groove 206 comprises a first side and a second side. The first side of the groove 206 is connected to a planar portion of the bottom surface 202 by an edge; the second side of the groove 206 is connected to another planar portion of the bottom surface 202 by another edge. The first side of each groove 206 opposes the second side of that groove 206. The first side and second side extend in respective planes corresponding to the axis along which the groove 202 extends.

A portion 208 of the first side extends along a plane oblique to the first plane. A portion 210 of the second side extends along a plane perpendicular to the first plane.

The sintered cathode sheet 200 comprises at least one groove 212 in the top surface 204 of the sintered cathode sheet. In the portion of sintered cathode sheet 200 depicted in FIG. 2, there are two grooves 212 in top surface 204 of the sintered cathode sheet 204. The grooves 212 extend along axes parallel to each other, in a direction perpendicular to the cross-section of FIG. 2 and parallel to the second plane. Planar portions of the top surface 204 extend along the second plane between the grooves 212. The planar portion of the top surface 204 corresponds to the top surface 606 of the electrochemical cell 600 described with reference to FIGS. 6A to 6D.

Each groove 212 of the top surface 204 has a corresponding groove 206 in the bottom surface 202. The groove 212 of the top surface 204 is off-set from its corresponding groove 206 in the bottom surface 202; the axes along which both grooves in the top and bottom surface 206, 212 extend together lie along a plane oblique to the first plane along which the bottom surface 202 extends and the second plane along which the second surface 204 extends. This oblique plane is depicted in FIG. 2 with dashed lines A and B. Each groove 212 of the top surface 204 has the same off-set from its corresponding groove 206 in the bottom surface 202.

Each groove 212 in the top surface 204 comprises a first side and a second side. The first side of the groove 212 is connected to a planar portion of the top surface 204 by an edge; the second side of the groove 212 is connected to another planar portion of the top surface 204 by another edge. The first side of each groove 212 opposes the second side of that groove 212. The first side and second side extend in respective planes corresponding to the axis along which the groove 202 extends.

As explained above, each groove 206 in the bottom surface 202 and each groove 212 in the top surface 204 comprises a portion 208, 214 of a first side of the respective groove which extends along a plane oblique to the first and second plane, and parallel to the axes along which the grooves 206, 212 extend. In this example, the portions 208, 214 of the first sides of the bottom and top grooves 206, 212 extend along a plane parallel to the oblique plane depicted in FIG. 2 with dashed lines A and B.

FIG. 2B depicts oblique planes 250, 260 as referred to herein with reference to axes x, y, and z, defining a three-dimensional cartesian space. The first plane 250 lies along the x and z axes in the three-dimensional space, and does not extend along the y axis. The second plane extends along the z axis, and extends along the x-y space (but not parallel to either axis). The dihedral angle θ at the intersection of the first and second planes 250, 260 is not equal to 90° nor 180°. Accordingly, the planes 250, 260 are oblique to one another; the second plane 260 is oblique to the first plane 250.

In the example depicted in FIG. 2B, both the first plane 250 and second plane 260 extend along the z axis; both the first plane 250 and second plane 260 extend along one dimension in common. Accordingly, the planes 250, 260 are inclined to one another; the second plane 260 is inclined to the first plane 250.

In any of the examples described herein, each of the oblique plane(s) referred to is suitably an inclined plane e.g. as depicted in FIG. 2B.

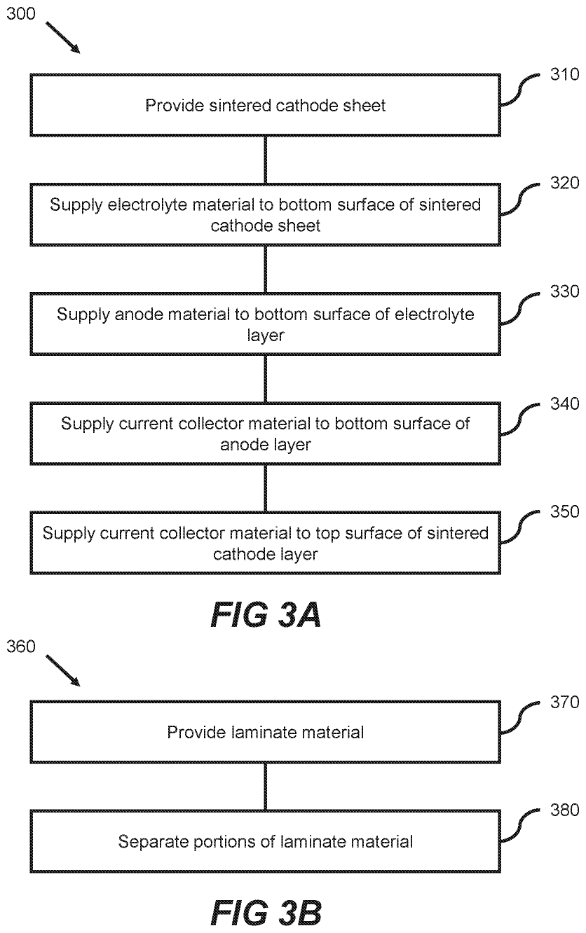

FIG. 3A is a flow chart of a method of providing a laminate material according to examples.

The method 300 comprises providing 310 a sintered cathode sheet. In this example, the sintered cathode sheet is the sintered cathode sheet 200 depicted in FIG. 2 which in turn is the product of the method 100 depicted in FIG. 1. The reference numerals of FIGS. 1 and 2 are referred to in describing the method 300 depicted in FIG. 3, purely to aid the understanding of the reader.

The method 300 further comprises supplying 320 an electrolyte material to the bottom surface 202 of the sintered cathode sheet 200. In this example, the electrolyte material comprises LiPON, such that the electrolyte layer formed is a LiPON layer.

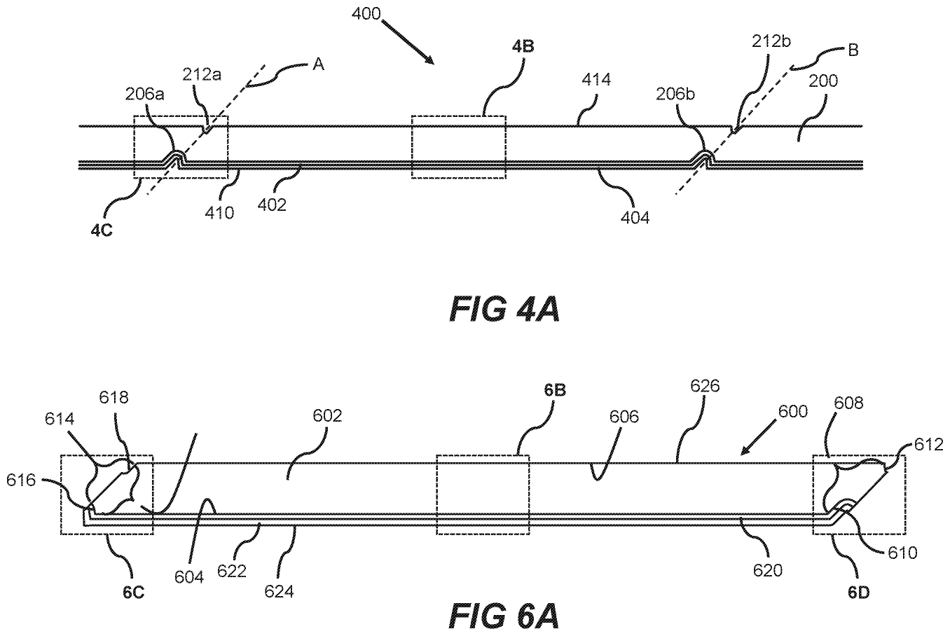

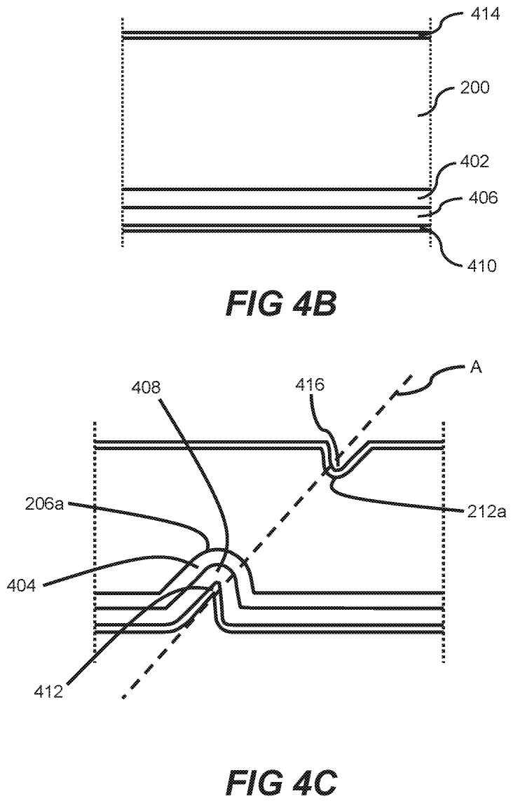

The electrolyte material is supplied 320 such that an electrolyte layer of substantially uniform thickness is provided on the bottom surface of the sintered cathode layer. Accordingly, the electrolyte layer is shaped such that the bottom surface of the electrolyte layer has a groove corresponding to the groove 206 of the bottom layer of the sintered cathode sheet 200, as explained further hereinbelow with respect to FIGS. 4A and 4C.

The method 300 further comprises supplying 330 anode material to the bottom surface of the electrolyte layer. The anode material is supplied 330 such that an anode layer of substantially uniform thickness is provided on the bottom surface of the electrolyte layer.

The method 300 further comprises supplying 340 current collector material to the anode layer.

The method 300 further comprises supplying 350 current collector material to the top layer of the sintered cathode layer.

FIG. 3B is a flow chart of a method 360 of providing a solid-state electrochemical cell according to examples.

The method 360 comprises providing 370 a laminate material. In this example, the providing 370 the laminate material corresponds to the method 300 of providing a laminate material described in relation to FIG. 3A.

The method 360 further comprises separating 380 a first portion of the laminate material from a second portion to provide a solid-state electrochemical cell. The separating comprises laser cutting of the laminate material. The portions of laminate material are separated along the oblique plane along which the axes of the groove in the top surface and groove in the bottom surface of the sintered cathode sheet lie.

The method 360 of providing a solid-state electrochemical cell is performed after the method 300 of providing a laminate material is performed. In examples (not shown), the methods 300, 360 are performed at a single site as part of a single manufacturing flow. In further examples (not shown), the method of providing the sintered cathode layer 100, the method of providing a laminate material 300, and the method of providing a solid-state electrochemical cell are performed at a single site as part of a single manufacturing flow.

FIG. 4A is a schematic diagram of a cross-section of a portion of a laminate material 400 according to examples, e.g. a laminate material 400 provided by the method 300 depicted in FIG. 3. FIG. 4B is an enlarged view of the portion of laminate material enclosed by the dashed-line box marked “4B” in FIG. 4A; FIG. 4C is an enlarged view of the of the portion of laminate material enclosed by the dashed-line box marked “4C” in FIG. 4A.

The laminate material 400 comprises a sintered cathode layer. In this example, the sintered cathode layer is the sintered cathode sheet 200 depicted in FIG. 2 which in turn is the product of the method 100 depicted in FIG. 1. The reference numerals of FIG. 2 are referred to in describing the laminate material 400 depicted in FIGS. 4A, 4B and 4C, purely to aid the understanding of the reader.

The sintered cathode layer 200 comprises a plurality of grooves 206a, 206b in the bottom surface 202 of the sintered cathode layer 200, and a plurality of grooves 212a, 212b in the top surface 204 of the sintered cathode layer. These grooves 206a, 206b, 212a, 212b are arranged as disclosed hereinabove in relation to FIG. 2.

An electrolyte layer 402 is arranged on the bottom surface 202 of the sintered cathode layer 200. The electrolyte layer 402 juxtaposes the sintered cathode layer 200, e.g. the electrolyte layer 402 has a bottom surface and a top surface, and the top surface of the electrolyte layer 402 abuts the bottom surface 202 of the sintered cathode layer 200.

The electrolyte layer 402 is of a substantially uniform thickness (e.g. the shortest distance between the bottom surface and top surface of the electrolyte layer 402 is substantially the same at any point across the electrolyte layer 402).

The electrolyte layer 402 has a shape such that the bottom surface of the electrolyte layer 402 has a plurality of grooves 404 which correspond to the plurality of grooves 206a, 206b of the bottom layer of the sintered cathode layer 200 which the electrolyte layer 402 covers.

An anode layer 406 is arranged on the bottom surface of the electrolyte layer 402. The anode layer 406 juxtaposes the electrolyte layer 402, e.g. the anode layer 406 has a bottom surface and a top surface, and the top surface of the anode layer 406 abuts the bottom surface of the electrolyte layer 402.

The anode layer 406 is of a substantially uniform thickness. The anode layer 406 has a shape such that the bottom surface of the anode layer 406 has a plurality of grooves 408 which correspond to the plurality of grooves 404 of the electrolyte layer 402 which the anode layer 406 covers.

An anode current collector 410 is arranged on the bottom surface of the anode layer 406. The anode current collector 410 juxtaposes the anode layer 406, e.g. the anode current collector 410 has a bottom surface and a top surface, and the top surface of the anode current collector 410 abuts the bottom surface of the anode layer 406.

The anode current collector 410 is of a substantially uniform thickness. The anode current collector 410 has a shape such that the bottom surface of the anode current collector 410 has a plurality of grooves 412 which correspond to the plurality of grooves 412 of the anode layer 406 which the anode current collector 410 covers.

A cathode current collector 414 is arranged on the top surface 204 of the sintered cathode sheet 200. The cathode current collector 414 juxtaposes the sintered cathode layer 200, e.g. the cathode current collect 414 has a bottom surface and a top surface, and the bottom surface of the cathode current collector abuts the top surface 204 of the sintered cathode sheet 200.

The cathode current collector 414 is of substantially uniform thickness. The cathode current collector 414 has a shape such that the top surface of the cathode current collector 414 has a plurality of grooves 416 which correspond to the plurality of grooves 212 of the sintered cathode layer 200 which the cathode current collector 414 covers.

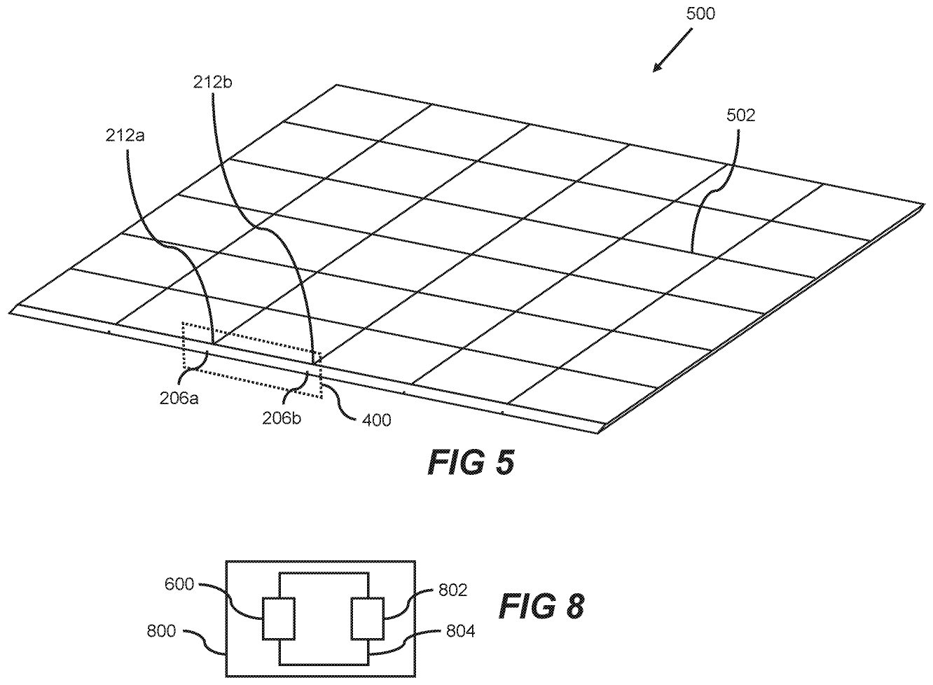

FIG. 5 is a schematic diagram of a perspective view of a laminate material 500 according to examples. The portion of laminate material 400 depicted in FIG. 4A corresponds to the portion of laminate material enclosed by the dashed-line box marked “400” in FIG. 5.

As well as the plurality of grooves in the bottom surface 206a, 206b and top surface 212a, 212b which extend along axes perpendicular to the plane of the cross-section of FIG. 4A, the laminate material 500 depicted in FIG. 5 includes a plurality of grooves 502 which extend along the first plane and along respective axes which are perpendicular to the axes of the plurality of grooves 212a, 212b in the top surface of the laminate material depicted in FIG. 4A. In examples (not shown), the laminate material is separated along these grooves 502 to provide solid-state electrochemical cells having a size and shape suitable for stacking in a battery stack.

FIG. 6A is a schematic diagram of a cross-section of a solid-state electrochemical cell 600 according to examples. FIG. 6B is an enlarged view of the portion of the solid-state electrochemical cell enclosed by the dashed-line box marked “6B” in FIG. 6A; FIG. 6C is an enlarged view of the portion of the solid-state electrochemical cell enclosed by the dashed-line box marked “6C” in FIG. 6A; and FIG. 6D is an enlarged view of the portion of the solid-state electrochemical cell enclosed by the dashed-line box marked “6D” in FIG. 6A.

The solid-state electrochemical cell 600 depicted in FIGS. 6A to 6D is obtained by cutting (e.g. laser cutting) the laminate structure 400 along the oblique planes A, B depicted in FIG. 4A.

The solid-state electrochemical cell 600 comprises a sintered cathode layer 602. The sintered cathode layer 602 comprises a bottom surface 604 extending along a first plane, and a top surface 606 opposing the bottom surface 604, the top surface extending along a second plane parallel to the first plane.

The sintered cathode layer 602 further comprises a first side surface 608. The first side surface 608 comprises a first portion 610 connected to the bottom surface 604 of the sintered cathode layer 602 by a first bottom side edge. The first portion 610 extends along a plane oblique to the first plane. In the example depicted in FIGS. 6A to 6D, the first portion 610 of the first side surface 608 extends along a plane substantially parallel to the plane along which the laminate material 400 was cut to provide the solid-state electrochemical cell 600, which itself is a plane oblique to the first plane. The first side surface 608 also comprises a second portion 612 connected to the top surface 606 of the sintered cathode layer 602 by a first top side edge. In the example depicted in FIGS. 6A to 6D, the second portion 612 extends along a plane substantially perpendicular to the second plane.

The sintered cathode cell further comprises a second side surface 614, opposing the first side surface 608. The second side surface 614 comprises a first portion 616 connected to the bottom surface 604 of the sintered cathode layer 602 by a second bottom side edge. In the example depicted in FIGS. 6A to 6D, the first portion 616 of the second side surface 608 extends along a plane substantially perpendicular to the first plane. The second side surface 608 also comprises a second portion 618 connected to the top surface 606 of the sintered cathode layer 602 by a second top-side edge. In the example depicted in FIGS. 6A to 6D, the second portion 618 of the second side surface 614 extends along a plane substantially parallel to the plane along which the laminate material 400 was cut to provide the solid-state electrochemical cell, which itself is a plane oblique to the second plane.

The solid-state electrochemical cell 600 further comprises an electrolyte layer 620 arranged on the bottom surface 604 of the sintered cathode layer 602. The electrolyte layer 620 has a bottom surface and top surface. The top surface of the electrolyte layer 620 abuts the first portion 610 of the first side surface 608 of the sintered cathode layer 602, the bottom surface 604 of the sintered cathode layer 602, and the first portion 616 of the second side surface 614 of the sintered cathode layer 602. The electrolyte layer 620 therefore coats the sintered cathode layer 602 beyond the first and second bottom-side edges, and comprises a first side portion (covering the first portion 610 of the first side surface 608 of the sintered cathode layer 602), a central portion (covering the bottom surface 604 of the sintered cathode layer 602) and a second side portion (covering the first portion 616 of the second side surface 614 of the sintered cathode layer 602). The first side portion comprises a portion of the bottom surface, a portion of the top surface, and a first side surface of the electrolyte layer 620, the first side surface connected to the bottom and top surfaces of the electrolyte layer 620 by respective first bottom-side and first top-side edges. The second side portion comprises a portion of the bottom surface, a portion of the top surface, and a second side surface of the electrolyte layer 620, the second side surface connected to the bottom and top surfaces of the electrolyte layer 620 by respective second bottom-side and second top-side edges.

The solid-state electrochemical cell 600 further comprises an anode layer 622 arranged on the electrolyte layer 620. The anode layer 622 has a bottom surface and a top surface.

The top surface of the anode layer 622 abuts the bottom surface of the electrolyte layer 620 along the first side portion, central portion, and second side portion of the electrolyte layer 620, such that the anode layer 622 comprises a first side portion (covering the bottom surface of the first side portion of the electrolyte layer 620—the first side portion of the anode layer 622 is arranged on the first portion 610 of the first side surface 608 of the sintered cathode layer 602), a central portion (covering the bottom surface of the central portion of the electrolyte layer 620), and a second side portion (covering the bottom surface of the second side portion of the electrolyte layer 620-the second side portion of the anode layer 622 is arranged on the first portion 616 of the second side surface 614 of the sintered cathode layer 602).

The solid-state electrochemical cell 600 further comprises an anode current collector 624 arranged on the anode layer 622. The anode current collector 624 has a bottom surface and a top surface. The top surface of the anode current collector 624 abuts the bottom surface of the anode layer 622 along the first side portion, (covering the bottom surface of the first side portion of the anode layer 622-the first side portion of the anode current collector 624 is arranged on the first portion 610 of the first side surface 608 of the sintered cathode layer 602), a central portion (covering the bottom surface of the central portion of the anode layer 622), and a second side portion (covering the bottom surface of the second side portion of the anode layer 622—the second side portion of the anode current collector 624 is arranged on the first portion 616 of the second side surface 614 of the sintered cathode layer 602).

The solid-state electrochemical cell 600 further comprises a cathode current collector 626 arranged on the sintered cathode layer 602. The cathode current collector 626 has a bottom surface and a top surface. The bottom surface of the cathode current collector 626 abuts the second portion 612 of the first side surface 608 of the sintered cathode layer 602, the top surface of the 606 of the sintered cathode layer 602, and the second portion 618 of the second side surface 614 of the sintered cathode layer 602. The cathode current collector 626 therefore coats the sintered cathode layer 602 beyond the first and second top-side edges, and comprises a first side portion (covering the second portion 612 of the first side surface 608 of the sintered cathode layer 602), a central portion (covering the top surface 606 of the sintered cathode layer 602) and a second side portion (covering the second portion 618 of the second side surface 614 of the sintered cathode layer 602).

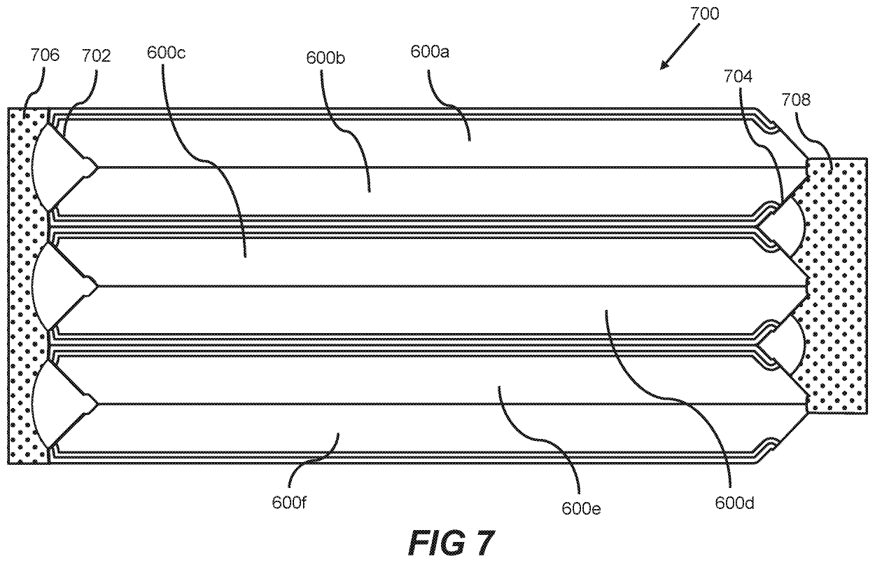

FIG. 7 is a schematic diagram of a cross-section of a battery stack 700 according to examples. The battery stack 700 comprises a plurality of solid-state electrochemical cells 600a, 600b, 600c, 600d, 600e, 600f, each of which corresponds to the solid-state electrochemical cell 600 depicted in FIGS. 6A to 6D. The reference numerals of FIGS. 6A to 6D are referred to in describing the battery stack 700, the reference numerals appended with letter indices to indicate the cell within the stack that the reference numeral refers to. These reference numerals are included purely to aid the understanding of the reader.

The plurality of electrochemical cells 600a, 600b, 600c, 600d, 600e, 600f comprises a first electrochemical cell 600a and a second electrochemical cell 600b arranged such that the cathode current collector 626a of the first electrochemical cell 600a abuts the cathode current collector 626b of the second electrochemical cell 600b; the top surfaces of the cathode current collectors 626 contact each other along the central portion of each cathode current collector 626.

The plurality of electrochemical cells further comprises a third electrochemical cell 600c arranged such that the anode current collector of the third electrochemical cell 624c abuts the anode current collector 624b of the second electrochemical cell 600b; the bottom surfaces of the anode current collectors 624 contact each other along the central portion of each anode current collector 624.

Further electrochemical cells 600d, 600e, 600f are comprised in the plurality of cells, arranged in the same manner as the arrangement of first 600a, second 600b, and third 600c electrochemical cells described above.

For each cell in the plurality of cells 600a, 600b, 600c, 600d, 600e, 600f, the second side portion of the cathode current collector 626 (the portion of cathode current collector 626 arranged on the second portion 618 of the second side surface 614 of the sintered cathode layer 602) is coated with an electrically-insulating material 702. The second sides of the electrolyte layer 620 and anode layer 622 at the second side of each cell, and the portion of the second side 614 of the sintered cathode layer 602 which is not covered by electrolyte layer 620 or cathode current collector 626, are also coated with the electrically-insulating material 702.

For each cell, only the bottom surface of the second side portion of the anode current collector 624 (the portion of the anode current collector 624 arranged on the first portion 616 of the second side surface 614 of the sintered cathode layer 602) is not coated with the electrically-insulating material 702 at the second side of each cell, e.g. only a portion of the anode current collector 624 of each cell is exposed at the second side of the cell.

For each cell in the plurality of cells 600a, 600b, 600c, 600d, 600e, 600f, the first side portion of the anode current collector 624 (the portion of anode current collector 624 arranged on the first portion 610 of the first side surface 608 of the sintered cathode layer 602) is coated with an electrically-insulating material 704. The first sides of the electrolyte layer 620 and anode layer 622 at the first side of each cell, and part of the portion of the first side 608 of the sintered cathode layer 602 which is not covered by electrolyte layer 620 or cathode current collector 626, are also coated with the electrically-insulating material 704.

In examples (not shown), the entire portion of the first side 608 of the sintered cathode layer 602 which is not covered by electrolyte layer 620 or cathode current collector 626 is coated with the electrically-insulated material 704.

For each cell, the first side portion of the cathode current collector 626 (the portion of the cathode current collector 626 arranged on the second portion 612 of the first side surface 608 of the sintered cathode layer 602) is not coated with the electrically-insulating material at the first side of each cell, e.g. a portion of the cathode current collector 626 of each cell is exposed at the first side of the cell.

At the second side of the cells, the battery stack 700 comprises an electrically-conductive material 706 abutting the exposed portions of anode current collectors 624 such that the anode current collectors 624 of the electrochemical cells 600a, 600b, 600c, 600d, 600e, 600f are electrically connected at the second side. Importantly, the anode current collectors 624 are not electrically connected to the cathode current collectors 626 at the second side by virtue of the electrically-insulating material 702 coating the second side portion of the cathode current collector of each cell.

At the first side of the cells, the battery stack 700 comprises an electrically-conductive material 708 abutting the exposed portions of cathode current collectors 626 such that the cathode current collectors 626 of the electrochemical cells 600a, 600b, 600c, 600d, 600e, 600f are electrically connected at the first side. Importantly, the cathode current collectors 626 are not electrically connected to the anode current collectors 624 at the first side by virtue of the electrically-insulating material 704 coating the first side portion of the anode current collector 624 of each cell.

FIG. 8 is a schematic diagram of an electrically-powered device 800 according to examples.

The electrically-powered device 800 comprises the solid-state electrochemical cell 600 depicted in FIGS. 6A to 6D. In examples (not shown), the solid-state electrochemical cell 600 is provided as part of a battery stack, such as the battery stack 700 depicted in FIG. 7.

The electrically-powered device comprises an element 802 which converts electric power from the solid-state electrochemical cell 600 to another form of energy (e.g. mechanical work, heat, light, and so on). The solid-state electrochemical cell 600 and element 800 are connected by one or more electrical conduits 804 which, in examples, forms an electrical circuit.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A solid-state electrochemical cell comprising:
a sintered cathode layer comprising:
a bottom surface extending along a first plane;
a top surface opposing the bottom surface, the top surface extending along a second plane relative to the first plane;
a first side surface comprising:
a first portion connected to the bottom surface of the sintered cathode layer by a first bottom side edge, the first portion extending along a plane oblique to the first plane; and
a second portion connected to the top surface of the sintered cathode layer by a first top side edge; and
a second side surface opposing the first side surface, the second side surface comprising:
a first portion connected to the bottom surface of the sintered cathode layer by a second bottom side edge; and
a second portion connected to the top surface of the sintered cathode layer by a second top-side edge, the second portion extending along a plane oblique to the second plane;
an electrolyte layer arranged on at least part of the bottom surface, the first portion of the first side surface, and the first portion of the second side surface of the sintered cathode layer;
an anode layer arranged on at least part of the electrolyte layer;
an anode current collector arranged on at least part of the anode layer; and
a cathode current collector arranged on at least part of the top surface, the second portion of the first side surface, and the second portion of the second side surface of the sintered cathode layer.

2. The solid-state electrochemical cell according to claim 1, wherein the second plane along which the top surface of the sintered cathode layer extends is substantially parallel to the first plane along which the bottom surface of the sintered cathode layer extends.

3. The solid-state electrochemical cell according to claim 1, wherein the second portion of the first side surface extends along a plane which is at least one of: oblique to the plane along which the first portion of the first side surface extends; perpendicular to the plane along which the first portion of the first side surface extends; oblique to the second plane; or perpendicular to the second plane.

4. The solid-state electrochemical cell according to claim 1, wherein the first portion of the second side surface extends along a plane which is at least one of: oblique to the plane along which the second portion of the second side surface extends; perpendicular to the plane along which the second portion of the second side surface extends; oblique to the first plane; or perpendicular to the first plane.

5. A method of providing a sintered cathode sheet, the method comprising:
providing a cathode sheet comprising a bottom surface extending along a first plane and a top surface extending along a second plane relative to the first plane;
scoring the bottom surface of the cathode sheet to provide a groove in the bottom surface of the cathode sheet, wherein at least a portion of a first side of the groove extends along a plane oblique to the first plane; and
sintering the cathode sheet, thereby providing the sintered cathode sheet.

6. The method according to claim 5, wherein at least a portion of a second side of the groove of the bottom surface, opposed the first side of the groove of the bottom surface, extends along a plane perpendicular to the first plane.

7. The method according to claim 5, further comprising scoring the top surface of the sintered cathode sheet to provide a groove in the top surface of the sintered cathode sheet, wherein at least a portion of a first side of the groove extends along a plane oblique to the second plane.

8. The method according to claim 7, wherein at least a portion of a second side of the groove of the top surface, opposed the first side of the groove of the top surface, extends in a plane perpendicular to the second plane.

9. The method according to claim 5, wherein the second plane is substantially parallel to the first plane.

10. The method according to claim 5, wherein the providing the cathode sheet comprises:
providing particulate cathode material; and
forming the particular cathode material into a sheet of cathode material.

11. A laminate material comprising:
a sintered cathode layer comprising a bottom surface extending along a first plane and a top surface extending along a second plane relative to the first plane, the sintered cathode sheet comprising at least one groove along the bottom surface of the sintered cathode layer wherein at least a portion of a first side of the groove extends along a plane oblique to the first plane;
an electrolyte layer arranged on at least part of the bottom surface of the sintered cathode layer and the groove of the bottom surface of the sintered cathode layer, the electrolyte layer comprising a groove corresponding to the groove of the sintered cathode layer;
an anode layer arranged on at least part of the electrolyte layer including at least part of the groove of the electrolyte layer, the anode layer comprising a groove corresponding to the groove of the electrolyte layer;
an anode current collector arranged on at least part of the anode layer including at least part of the groove of the anode layer, the anode current collector comprising a groove corresponding to the groove of the anode layer; and
a cathode current collector arranged on at least part of the sintered cathode layer.

12. The laminate material according to claim 11, the sintered cathode sheet comprising at least one groove along the top surface of the sintered cathode layer, at least a portion of a first side of the groove extending along a plane oblique to the second plane,
wherein the cathode current collector is arranged on at least part of the top surface of the sintered cathode sheet including at least part of the groove of the top surface of the sintered cathode layer, the cathode current collector comprising a groove corresponding to the groove of the sintered cathode layer.

13. The laminate material according to claim 12, wherein the at least one groove in the top surface of the sintered cathode sheet is a plurality of grooves comprising a first groove and a second groove, the first groove and second groove extending along substantially parallel axes.

14. The laminate material according to claim 12, the sintered cathode sheet further comprising at least one perpendicular groove in the top surface of the sintered cathode sheet, the perpendicular groove extending along an axis perpendicular to the at least one groove in the top surface of the sintered cathode sheet.

15. The laminate material according to claim 11, wherein the at least one groove in the bottom surface of the sintered cathode sheet is a plurality of grooves comprising a first groove and a second groove, the first groove and second groove extending along substantially parallel axes.

16. A method of providing a laminate material, the method comprising:
providing a sintered cathode sheet by a method according to claim 5;
supplying an electrolyte material to at least a portion of the bottom surface of the sintered cathode sheet including the groove, thereby providing an electrolyte layer having a groove corresponding to the groove in the bottom surface of the sintered cathode sheet; and
supplying an anode material to at least a portion of the electrolyte layer, thereby providing an anode layer comprising a groove corresponding to the groove of the electrolyte layer.

17. The method according to claim 16, further comprising supplying a current collector material to at least a portion of the anode layer, thereby providing an anode current collecting comprising a groove corresponding to the groove of the anode layer.

18. The method according to claim 16, wherein:
the providing the sintered cathode sheet comprises scoring the top surface of the cathode sheet to provide a groove in the top surface of the cathode sheet, at least a portion of a first side of the groove extending along a plane oblique to the second plane;
the method further comprising:
supplying a current collector material to at least a portion of the top surface of the sintered cathode sheet including the groove, thereby providing a current collector layer comprising a groove corresponding to the groove in the top surface of the sintered cathode sheet.

19. A method of providing a solid-state electrochemical cell comprising providing a laminate material according to claim 12, and separating a first portion of the laminate material from a second portion of the laminate material, thereby providing at least one solid-state electrochemical cell.

20. The method according to claim 19, wherein the separating comprises cutting the laminate material along a plane connecting the groove of the bottom surface of the sintered cathode sheet and the groove of the top surface of the sintered cathode sheet.

21. The method according to claim 20, wherein the plane of cutting corresponds to the plane along which the portion of the first side of the groove of the bottom surface of the sintered cathode sheet extends and/or the plane along which the portion of the first side of the groove of the top surface of the sintered cathode sheet extends.

22. A battery stack comprising a plurality of laminate electrochemical cells according to claim 1.

23. The battery stack according to claim 22, wherein the plurality of electrochemical cells comprises a first electrochemical cell and a second electrochemical cell, configured such that the anode current collector of the first cell abuts the anode current collector of the second cell.

24. The battery stack according to claim 22, wherein for each of the electrochemical cells, the portion of cathode current collector arranged on the second portion of the second side surface of the sintered cathode layer is coated with an electrically-insulating material.

25. The battery stack according to claim 22, wherein for each of the electrochemical cells, a portion of the anode current collector corresponding to the first portion of the first side surface of the sintered cathode layer is coated with an electrically-insulating material.

26. The battery stack according to claim 22, comprising an electrically-conductive material abutting the portion of cathode current collector arranged on the second portion of the first side surface of the sintered cathode layer of each electrochemical cell, such that the cathode current collectors of the electrochemical cells are electrically connected.

27. The battery stack according to claim 22, comprising an electrically-conductive material abutting a portion of the anode current collector corresponding to the first portion of the second side surface of the sintered cathode layer of each electrochemical cell, such that the anode current collectors of the electrochemical cells are electrically connected.
